(19) United States
(12) Patent Application Publication
(10) Pub. No.: US 2022/0097587 A1
(43) Pub. Date: Mar. 31, 2022

(54) VEHICLE MOUNTABLE COOKING PLATFORM

(71) Applicant: Fleming Sales Company, Elkhart, IN (US)

(72) Inventors: Jeffrey T. Grady, Sugar Grove, IL (US); Josh Vandiver, Edwardsburg, MI (US)

(73) Assignee: Fleming Sales Company, Elkhart, IN (US)

(21) Appl. No.: 17/032,573

(22) Filed: Sep. 25, 2020

(51) Int. Cl. B60N 3/16; B60R 9/06; B60R 11/00

(52) U.S. Cl. CPC B60N 3/16; B60R 9/06; B60R 11/00; B60R 2011/0087; B60R 2011/005; B60R 2011/0064; B60R 2011/0082; B60R 2011/004

(57) ABSTRACT

A platform that can hold a cooking appliance is for use with an RV, camper, or other vehicle. A fixed portion is affixed to the rear bumper of the vehicle and is connected to a moving portion with a hinge. The platform is on the moving portion and is moved between a stowed position for travel and pivots away from the vehicle when the appliance is used. In the stowed position, the platform is closest to the rear wall of the vehicle. When the appliance is located on the platform, it overhangs the platform by a distance greater than the distance between the platform and the vehicle in the stowed position. The overhang prevents the appliance from being stored on the platform during transport because the appliance makes contact with the rear wall of the RV before the platform can rotate fully to the stored position.

### BACKGROUND OF THE INVENTION

This present disclosure relates to vehicle-mounted cooking devices, such as a grill or griddle. These can be mounted to a vehicle to provide an outdoor cooking experience during tailgating, camping, or other outdoor leisure activity. Most of the cooking devices available are designed to be stored as attached to the vehicle, creating an opportunity for theft, damage, or unauthorized users. Many recreational vehicles have flammable materials in or on the outside walls, like fiberglass or vacuum-formed plastic. It is possible for the existing devices to be used in the stored position, where they are likely very close to the outside wall of the vehicle, heat expelled can damage the outside wall or create a fire in the vehicle. Further, having a cooking appliance located at the rear of the vehicle during transport can result in fuel leaks, loss of unsecured components, or weather intrusion. A cooking appliance that is left on or turns on in the stored position during transport could create a dangerous fire. An improved device is needed.

### SUMMARY OF THE INVENTION

The present disclosure describes a mounted platform that can pivot between a use position and a storage position. The platform is connected to a frame that can be secured to a vehicle's rear bumper. The frame allows the platform to pivot between a stored position and a use position. In the stored position, the platform is adjacent but not in contact with the rear wall of the vehicle. The platform can receive and securely hold a cooking appliance, but only when the platform is not in the storage position. Once engaged with the platform, the cooking appliance overhangs the portion of the platform that is adjacent the rear wall of the vehicle in the stored position, and the overhang is greater than the distance between the platform and the rear wall. The cooking appliance must be removed before the platform can be moved completely to the storage position. The platform can only be locked or secured in the storage position.

### BRIEF DESCRIPTION OF THE DRAWINGS

FIG. 1 is an isometric view of the cooking platform in the stowed position as mounted to an RV;

FIG. 2 is an isometric side view of the cooking platform carrying a cooking appliance in the use position;

FIG. 3 is an isometric view of the cooking platform as mounted to an RV carrying a cooking appliance unable to return to the stowed position;

FIG. 4 is an exploded isometric view of the cooking platform;

FIG. 5 is a left side section view through the locating feet of the cooking platform as installed, showing the RV in hidden lines and the interference between the cooking appliance and RV if the cooking appliance was in place;

FIG. 6 is a right side view of the cooking platform as installed and in the stowed position;

FIG. 7 is a top view of the cooking platform fully away from the stowed position;

FIG. 8 is a bottom view of the cooking platform in the stowed position;

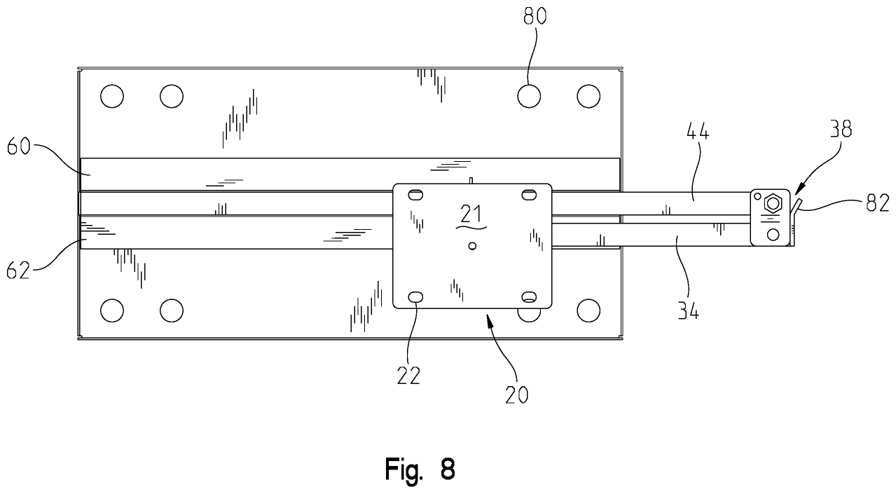

### DESCRIPTION OF THE PREFERRED EMBODIMENT

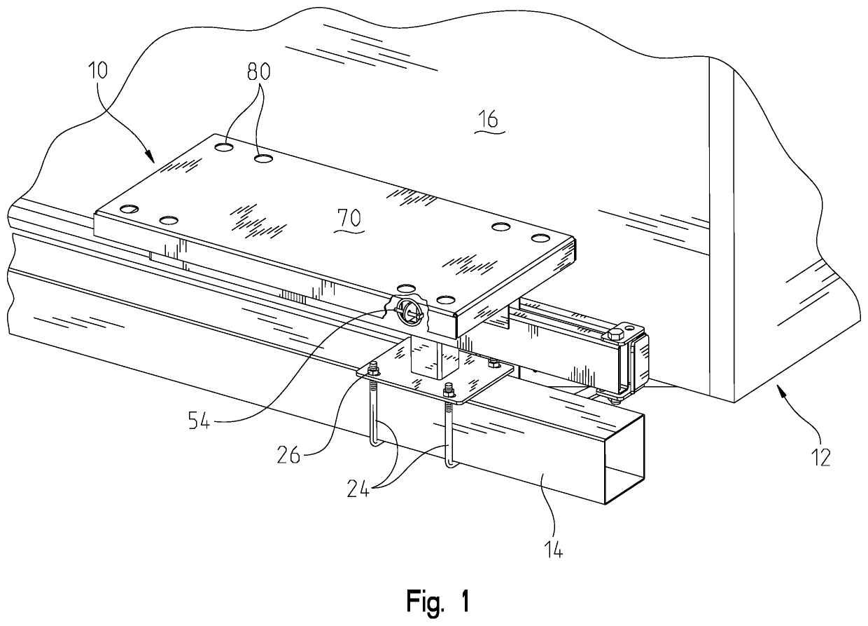

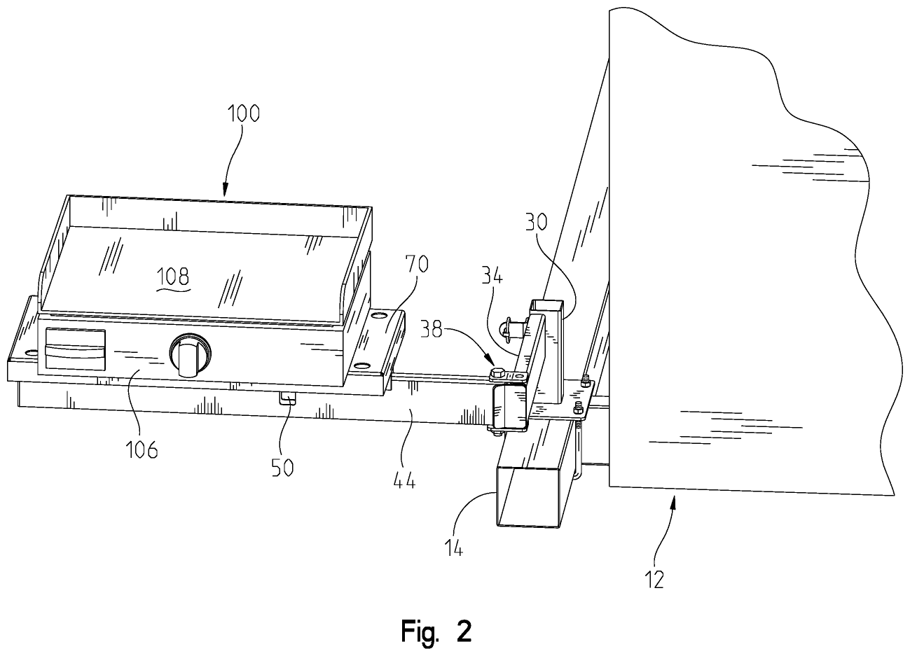

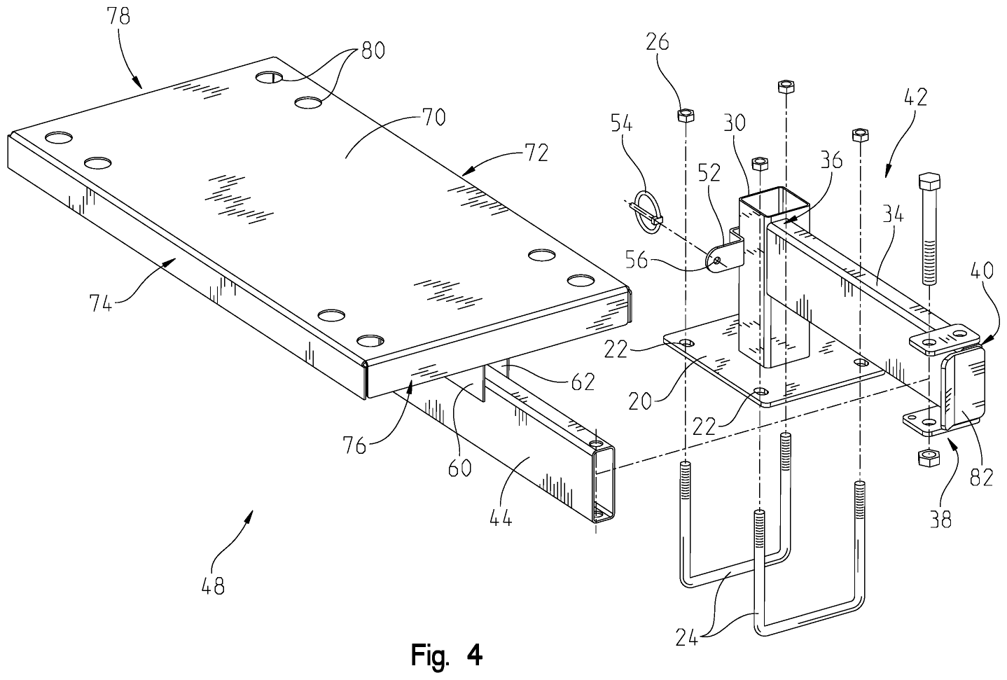

A vehicle-mounted cooking platform 10 is shown in FIGS. 1 and 2 as affixed to a vehicle 12. The vehicle 12 as shown is a recreational vehicle, camper, or trailer (RV) with a bumper 14 that is adjacent the rear wall 16. In the embodiment shown, the bumper 14 is spaced from the rear wall 16 by a small distance. The bumper 14 is typically a square tube securely affixed to the frame of the vehicle 12 and runs the width of the vehicle. With RVs, the rear wall 16 is commonly straight or flat, with a consistent gap between the bumper 14 and rear wall 16. A portion of the rear wall 16 may be at an angle near the bumper 14, but in any event, the bumper 14 is in close proximity to the rear wall 16. The platform 10 has a mounting foot 20 with a bumper-facing surface 21 and holes 22 that receive U-bolts 24. As shown in FIGS. 1-4, the U-bolts 24 are sized to fit around the bumper 14 and be secured with nuts 26.

As shown in FIG. 2, affixed to the mounting foot 20 is a vertical tube 30 that extends perpendicularly therefrom. A fixed frame member 34 is affixed to the vertical tube 30 and extends in one direction. As shown, the fixed frame member 34 is perpendicular to the vertical tube 30 and parallel to the mounting foot 20. The fixed frame member 34 is affixed to the vertical tube 30 at a proximal end 36 and has a hinge 38 at a distal end 40. The vertical tube 30, fixed frame member 34, and mounting foot 20 make up the fixed portion 42. A moving frame member 44 is connected to the hinge 38 and has an elongate tube. The moving frame member 44 has an aperture 50 that can receive a locking tang 52 which is affixed to the vertical tube 30 when the platform 10 is in the stored position, as shown in FIG. 1. Affixed to the moving frame member 44 are L-shaped rails 60, 62 that support an elevated platform 70. The platform 70, rails 60, 62, and moving frame member 44 make up the moving portion 48 and all move together and pivot about the hinge 38 between the stored position and a use position. The hinge 38 includes friction components (not shown) that provide resistance to movement that holds the moving portion 48 in position. The friction components prevent the moving portion 48 from moving unexpectedly, such as when the vehicle is parked on a slight incline, or when someone is moving around inside the vehicle. The elevated platform 70 is formed from a flat material such as sheet metal, and has an inside edge 72, an outside edge 74, and transverse edges 76, 78. The elevated platform 70 has locating apertures 80 extending through the thickness that are used to locate and hold a cooking appliance 100 when the moving portion 48 is away from the stored position. The embodiment shown herein has four locating apertures 80, which can accommodate two different sizes of cooking appliances 100. The locating apertures 80 are shown as an example and the number and location of the apertures 80 are not limited by the embodiment(s) shown.

The cooking appliance 100 has locating feet 102 that are complementary to the locating apertures 80 on the elevated platform 70. As shown, the cooking appliance 100 is a griddle with a main body 106 and a cooking surface 108. The cooking appliance 100 generates heat during use that can radiate outwardly and potentially damage any heat-sensitive item or surface that is in close proximity. The locating feet 102 are affixed to the main body 106 and protrude therefrom. The locating feet 102 fit into the locating apertures 80 to temporarily secure the cooking appliance 100. The locating apertures 80 are close to the inside and outside edges 72, 74, making it difficult to properly place the cooking appliance anywhere but in the locating apertures 80. Mating the locating feet 102 to the locating apertures prevents vibration, movement from cooking, or any accidental bump from dislodging the cooking appliance 100 from the elevated platform 70 and causing it to fall. The only way to securely place the cooking appliance 100 on the elevated platform 70 is with the locating feet 102 mated in a way that the appliance 100 overhangs the inside edge 72. The locating feet 102 and locating apertures 80 only allow the cooking appliance 100 to be securely positioned when the two are engaged, causing a portion of the appliance 100 to overhang the inside edge 72. The overhanging of the cooking appliance 100 is critical to proper operation and safe storage of the platform 10. The platform 10 is not intended to permanently store or mount the cooking appliance. The locating feet 102 only position the cooking appliance 100 in a location on the elevated platform 70 where it overhangs the inside edge 72.

As shown, the elevated platform 70 is a rectangular flat area with the locating apertures 80 disposed near the edges. Instead of having locating apertures 80, it is contemplated that the outside edges of the elevated platform 70, could have a profile that cradles portions of each of the locating feet 102 to accomplish the same goal of only allowing the cooking appliance 100 to be securely located in certain positions. All of the certain positions contemplated still would prevent the cooking appliance 100 from remaining on the elevated platform when the moving portion 48 is moved to the stored position.

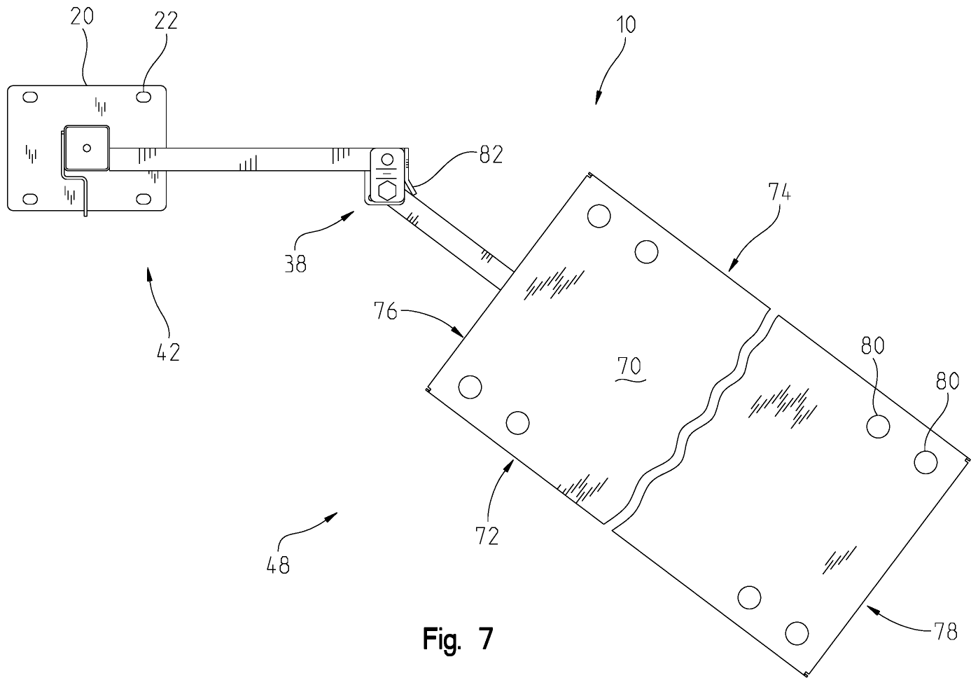

The stored position is defined by the locking tang 52 extending through the aperture 50 to be able to install a locking pin 54 in the locking aperture 56, shown in FIG. 1. In the stored position, the inside edge 72 of the elevated platform 70 overhangs the mounting foot 20 and the moving frame member 44 is adjacent to and parallel to the fixed frame member 34. Use positions are shown in FIGS. 2 and 7 and defined as the moving portion 48 pivoted away from the fixed portion 42. The angular movement of the moving portion 48 is limited by a stop 82. As shown in FIG. 7, the moving portion can move up to 140 degrees from the stored position, but other angles of movement are possible.

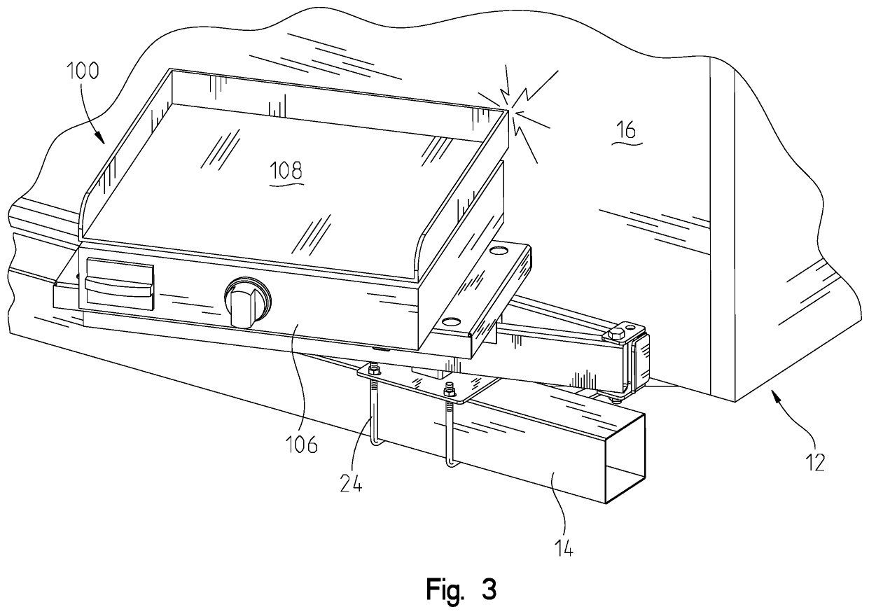

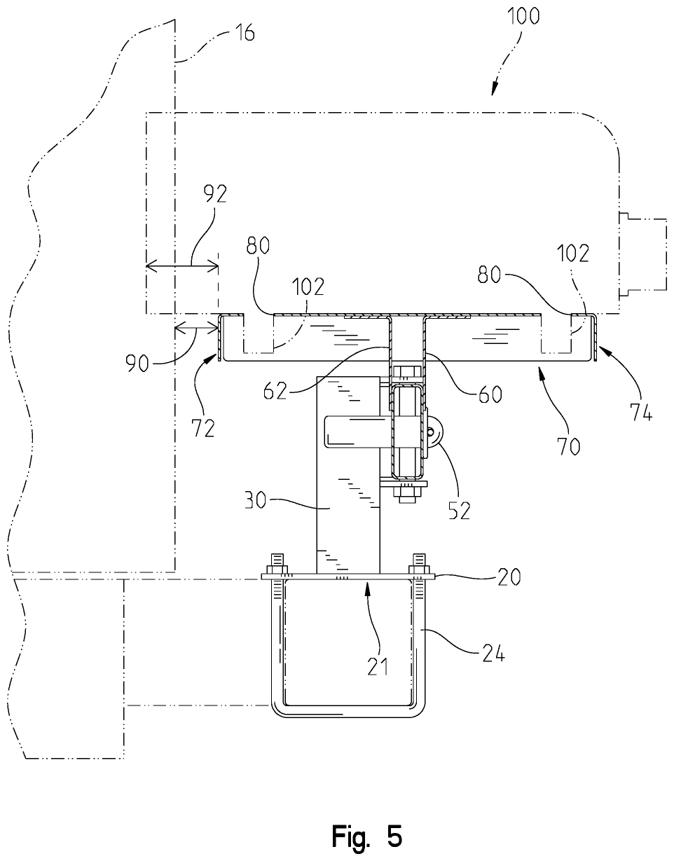

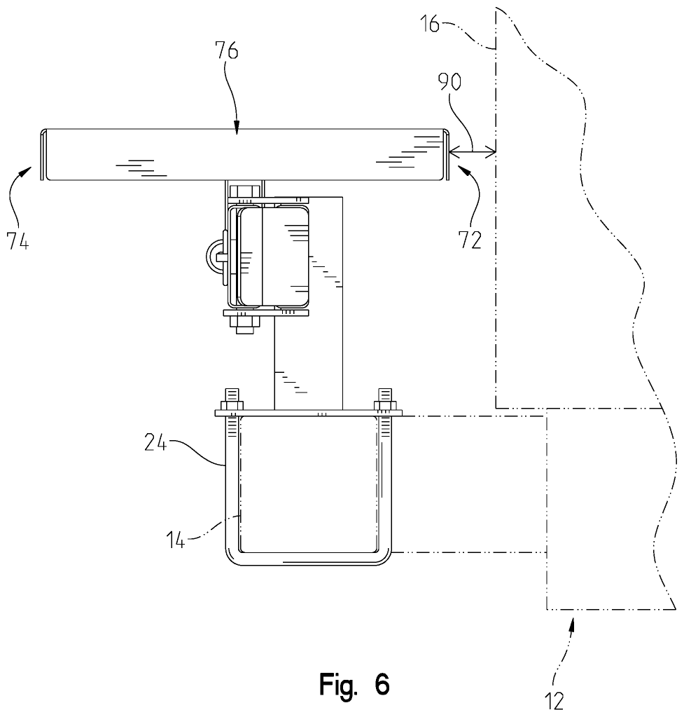

As affixed to the vehicle, the inside edge 72 is located close to but not in contact with the rear wall 16 when the platform 10 is in the stored position. This distance 90 is shown in FIGS. 5 and 6. By designing the platform 10 to locate the inside edge 72 close to the rear wall 16 in the stored position, and ensuring that the cooking appliance 100 can only be placed on the elevated platform 70 with a portion of the appliance overhanging the inside edge 72, the user is unable to leave the cooking appliance 100 on the elevated platform 70 and be able to position the moving portion 48 to the stored position. The overhanging distance 92 is larger than the distance 90, as shown in FIG. 5. The overhanging portion of the appliance 100 makes contact with the rear wall 16 before the locking tang 52 can extend through the aperture 50, shown in FIG. 3.

In the FIGS., the elevated platform 70 is shown as substantially centered over the moving frame member 44, but other positions are contemplated, based on the construction of the vehicle 12 and location of the bumper 14 with respect to the rear wall 16. For example, if the bumper 14 is farther away from the rear wall 16 than what is shown in FIG. 6, it could be possible that the cooking appliance 100 could remain on the elevated platform 70 in the stored position, defeating the purpose of the invention. In this application, the elevated platform 70 would be fixed with respect to the moving frame member 44 such that the distance between the inside edge 72 and rear wall 16 is minimized without making contact in the stored position. The opposite is also true. In the situation where the bumper 14 is very close to the rear wall 16, the elevated platform would be fixed with respect to the moving frame member 44 to allow a small gap between the inside edge 72 and rear wall 16 in the stored position.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. A movable arm in combination with a vehicle, said vehicle having a rear bumper adjacent to a rear wall, said arm for temporary use with a cooking appliance having locating feet, said movable arm comprising:
a fixed portion having a mounting foot for affixing to said bumper, said fixed portion having a locking tang extending therefrom, said locking tang having a locking aperture to receive a locking pin, a vertical tube affixed to said foot and a fixed frame member, said fixed frame member extending from said vertical tube in a direction parallel to said foot, said fixed frame member terminating at a hinge, said hinge opposite said vertical tube;
a moving portion having a platform with locating features in locations complementary to said locating feet on said cooking appliance, said platform affixed to a moving frame member, said moving portion having an aperture for receiving said locking tang;
said fixed portion pivotally connected to said moving frame member at said hinge, said moving portion movable with respect to said fixed portion between a stored position and a use position;
when said cooking appliance is located on said platform and said moving portion is pivoted towards said stored position, said cooking appliance contacts said rear wall before said moving portion reaches said stored position.

2. The movable arm in claim 1, wherein said platform has an inside edge spaced from said rear wall by a first distance in said stored position, when said cooking appliance is located on said platform, a portion of said cooking appliance overhangs said inside edge by a distance greater than said first distance.

3. The movable arm in claim 1, wherein said platform overlays said mounting foot in said stored position.

4. The movable arm in claim 1, wherein said locating features are apertures extending through said platform.

5. The movable arm in claim 1, wherein said fixed portion is affixed to said rear bumper with U-bolts.

6. The movable arm in claim 1, wherein said moving frame member is adjacent and parallel to said fixed frame member in said stored position.

7. The movable arm in claim 1, wherein said hinge includes a stop to limit the rotational movement of said moving portion about said hinge.

8. A movable arm for use with a vehicle having a rear bumper spaced from and adjacent to a rear wall, said arm for temporary use with a cooking appliance having locating feet, said arm comprising:
a fixed portion having a mounting foot and a vertical tube affixed thereto, said vertical tube extending in a direction opposite a bumper-facing surface on said mounting foot; said mounting foot including holes to receive U-bolts to secure said fixed portion to said rear bumper, said fixed portion having a fixed frame member affixed to and extending orthogonally from said vertical tube, a locking tang affixed to said fixed portion;
a moving portion having a moving frame member affixed to L-shaped rails, said L-shaped rails affixed to an elevated platform, said platform having locating apertures extending therethrough to complementarily receive said locating feet on said cooking appliance;
said fixed frame member pivotally affixed to said moving frame member at a hinge to allow said moving portion to pivot with respect to said fixed portion between a stored position and a use position, said stored position defined by said locking tang extending through an aperture on said moving portion;
when said cooking appliance is received by said elevated platform, said cooking appliance prevents said moving portion from reaching said stored position.

9. The movable arm in claim 8, wherein said locking tang is affixed to said vertical tube and said aperture is located on said moving frame member.

10. The movable arm in claim 8, wherein said cooking appliance overhangs said elevated platform to contact said rear wall before said moving portion reaches said stored position.

11. The movable arm in claim 8, wherein said elevated platform is spaced from said rear wall in said stored position by a first distance, said cooking appliance overhangs said elevated platform by a distance greater than said first distance when said cooking appliance is received by said elevated platform.

12. The movable arm in claim 8, wherein said moving frame member is adjacent and parallel to said fixed frame member in said stored position.

13. The movable arm in claim 8, wherein said hinge includes a stop to limit the rotational movement of said moving portion about said hinge.

14. An arm affixed to a vehicle for temporary use with a cooking appliance having locating feet extending therefrom, said vehicle having a bumper fixed with respect to a rear wall on said vehicle, said arm comprising:
a fixed portion pivotally connected to a moving portion at a hinge, said moving portion movable between a stored and a use position, said stored position defined by said moving portion fixable with respect to said fixed portion by a locking pin, said use position defined by said moving portion movable with respect to said fixed portion;
said fixed portion affixed to said bumper;
said moving portion having a platform affixed thereto for receiving and locating said cooking appliance, said cooking appliance overhanging said platform when located thereon;
when said cooking appliance is located on said platform, said cooking appliance stops said moving portion from being moved to said stored position.

15. The arm in claim 14, wherein said platform is spaced from said wall by a first distance when said moving portion is in said stored position, said overhanging of said cooking appliance is greater than said first distance.

16. The arm in claim 14, wherein a locking tang is affixed to a vertical tube to receive said locking pin and an aperture is located on a moving frame member.

17. The arm in claim 14, wherein said cooking appliance overhangs said platform to contact said rear wall before said moving portion reaches said stored position.

18. The arm in claim 14, wherein said elevated platform is spaced from said rear wall in said stored position by said first distance, said cooking appliance overhangs said elevated platform by a distance greater than said first distance when said cooking appliance is received by said elevated platform.

19. The arm in claim 14, wherein said moving frame member is adjacent and parallel to a fixed frame member in said stored position.

20. The arm in claim 14, wherein said hinge includes a stop to limit the rotational movement of said moving portion about said hinge.
